(19) United States
(12) Patent Application Publication
(10) Pub. No.: US 2011/0156584 A1
(43) Pub. Date: Jun. 30, 2011

(54) LED LIGHTING DEVICE

(75) Inventor: Hyun Min Kim, Seoul (KR)

(73) Assignee: SOLARKOR COMPANY LTD., Seoul (KR)

(21) Appl. No.: 13/060,747

(22) PCT Filed: Aug. 26, 2009
(86) PCT No.: PCT/KR2009/004747

§ 371 Date: Feb. 25, 2011

(30) Foreign Application Priority Data
Aug. 26, 2008 (KR) 10-2008-0083480
Aug. 26, 2008 (KR) 10-2008-0083481
Aug. 26, 2008 (KR) 10-2008-0083482

(51) Int. Cl. H01K 1/62; F21V 29/00

(52) U.S. Cl. 315/32; 362/294

(57) ABSTRACT

The present invention relates to a lighting device using an LED. One embodiment of the invention provides a lamp-shaped LED lighting device that can replace a known lighting device. The lamp-shaped LED lighting device promptly emits the heat generated by an LED element, which influences the optical output and the lifespan of the LED lighting device, through a lamp-shaped frame with a heat-ventilation structure that facilitates air circulation. In addition, the lamp-shaped LED lighting device prevents glare from an LED light source by using a lateral reflecting member, a diffusion lens and a diffusion cover and diffuses the light from the light source widely without optical attenuation. Another embodiment of the invention provides a tube and panel-shaped LED lighting devices that can be replaced with a previous tube-shaped fluorescent light and a panel-shaped lighting device. The tube and panel-shaped LED lighting devices rapidly emit the heat generated by an LED element, which influences the optical output and the life span of the LED lighting device, through a tube and panel-shaped frame with a heat-sink structure. In addition, the tube and panel-shaped LED lighting devices prevent glare from the LED light source by optically arranging a curved reflecting plate, a diffusion plate and a diffusion window which include a diffusion lens at the upper portion of the LED element. Furthermore the tube and panel-shaped LED lighting devices diffuse the light from the LED light source widely without optical attenuation.

### TECHNICAL FIELD

The present invention relates to a lighting device, and more particularly, to a lighting-emitting diode (LED) lighting device that prevents a light output and a lifespan of an LED element from being deteriorated and emits uniform lighting without glaring and optical attenuation with a convection dissipation type frame rapidly dissipating heat by using the LED element as a light source.

### BACKGROUND ART

In recent years, the LED element has been in the spotlight as a light source of diversified lighting devices. The LED element has advantages such as a lower heat dissipating amount, lower power consumption, a longer lifespan, higher impact-resistance, and the like than a known lighting source. Further, during manufacturing, since mercury or discharging gas is not used like a 00fluorescent lamp, the LED element has an advantage of not causing environmental pollution.

In the case in which appropriate power is supplied and an appropriate heat dissipating unit is provided to the LED element, although the LED element is used for 0.1 million hours or longer, the LED element can main a lighted state without any damage. Optical outputs of all light sources decrease gradually as time elapses. Since people cannot tell the difference at 80% of initial light intensity, the lifespan of the lighting LED element is presently expected to be approximately 40 to 50 thousand hours. Therefore, the LED element may be a much longer lifespan light source than an incandescent lamp having a lifespan of 1500 hours and the fluorescent lamp having a lifespan of 10 thousand hours.

However, when a driving current of the LED element increases in order to acquire a high-luminance, high-power lighting source, the power loss of the LED element increases, as a result, most of electric energy is converted into heat and a junction portion of the LED element is in a high-temperature state.

Even though a current flowing through the LED element is uniform, when the temperature of the junction portion increases, the LED element has characteristics in that an optical output and optical efficiency thereof deteriorate and the operating lifespan thereof decreases.

Accordingly, in order to improve lighting performance and the lighting lifespan, heat generated from the junction portion of the LED element must be discharged to the outside as quickly as possible.

In order to solve the problem, in the related art, a high-luminance LED element is mounted on a front surface of an integrated metallic housing in which cooling fins are formed on the circumference of a main body in diversified heat dissipating structures and a semicircular ivory diffusion cover is covered thereon to manufacture an LED lighting lamp. However, such a scheme has a problem in that a projection angle of the LED light source, optical attenuation increases by the ivory white diffusion cover to decrease illumination and thermal accumulation occurs in the diffusion cover to easily deteriorate the LED element, to thereby change a lighting color or shorten the lifespan.

Further, a general bulb type LED lighting lamp has a problem in that since a DC power supply, a metallic heat dissipating housing, a high-luminance LED element mounted on a front surface of the housing, and an ivory white diffusion cover are integrally joined to each other during manufacturing, when the illumination of an LED light source deteriorates, the LED element and the DC power supply integrally and elaborately mounted on the metallic housing are very difficult to replace, as a result, the entire product is generally discarded, thereby producing wastes and wasting resources.

Further, the LED element is a point light source emitting light in a semiconductor element and a light emitting surface of the LED element has a structure to collect light on a front surface thereof and dissipating the collected light by using a small reflection mirror and an epoxy lens. Accordingly, when the LED element emits light with high luminance in order to increase illumination, the light source is very glaring. Therefore, most of LED lighting lamps are used as the LED lighting lamp by covering the LED element with an ivory white circular diffusion cover or covering the LED light source with a diffused reflection plate made of a translucent material having an irregular uneven curve in order to prevent glaring.

The ivory white diffusion cover or irregular uneven diffused reflection plate reduces the quantity of light of the LED element to remarkably decrease illumination due to characteristics of an optical diffusion material and a diffusion reflection structure. Accordingly, additional high-luminance LED elements are mounted on a light source part by considering the reduced quantity of light, as a result, the amount of emitted heat is also doubled. Therefore, a heat radiating function must be further improved to meet the demand. Thus, a manufacturing cost largely increases and the LED lighting device becomes expensive.

Meanwhile, convection heat dissipation dissipates heat generated from the device by using a convection phenomenon and the convection heat dissipation represents that cold air introduced into the bottom of the device is heated hot by internal heat of the device and thereafter, discharged to the top by natural convection to prevent the device from being overheated.

### DISCLOSURE

### [Technical Problem]

The present invention is contrived to solve the problems and an embodiment of the present invention provides a lamp type LED lighting device that can rapidly discharges heat generated from an LED element that influences an optical output and a lifespan of the LED lighting device through a lamp type frame having a convection heat dissipation structure in which ventilation is smooth, and prevent an LED light source from glaring and widely diffuse a light source without optical attenuation by using a side reflection member and a diffusion lens and a diffusion cover.

Another embodiment of the present invention provides line type and panel type LED lighting devices that can replace the existing fluorescent lamp and panel type lighting device by rapidly discharging heat generated from an LED element that influences an optical output and a lifespan of the LED lighting device through a frame having smooth line type and panel type structures in which a heat dissipating operation is smooth, and preventing an LED light source from glaring and widely diffusing a light source without optical attenuation by optically placing a curved reflection plate with a diffusion lens and a diffusion plate and a diffusion window.

### [Technical Solution]

An embodiment of the present invention provides a lamp-shaped LED lighting device including: a housing cover having a socket fixed at one side thereof; a heat dissipating frame fixed to the other side of the housing cover, having at least three side reflecting portions formed on the outer peripheral surface thereof, and a ventilation unit having at least one ventilation hole formed at a portion which the end of the side reflecting portion contacts; an LED module fixed to the side reflecting portion of the heat dissipating frame and having an LED element; a power supply module unit installed in the heat dissipating frame; a side reflecting member fixed to the side reflecting portion of the heat dissipating frame to cover the LED module and having a boring hole formed at a location corresponding to an emission surface of the LED element; a frame cover coupled to be attached to and detached from the bottom of the heat dissipating frame; and a diffusion cover mounted on the side reflecting portion of the heat dissipating frame and having a toothed diffusion lens serving as refraction and diffusion operations installed on the inner periphery thereof, wherein at least one housing hole is formed on the housing cover.

An embodiment of the present invention provides a lamp-shaped LED lighting device including: a housing cover having a socket fixed at one side thereof; a power supply module housing coupled to be attached to and detached from the other side of the housing cover; a heat dissipating frame fixed to one side of the power supply module housing, having at least three side reflecting portions formed on the outer peripheral surface thereof, and a ventilation unit having at least one ventilation hole formed at a portion which the end of the side reflecting portion contacts; an LED module fixed to the side reflecting portion of the heat dissipating frame and having an LED element; a power supply module unit installed in the power supply module housing; a side reflecting member fixed to the side reflecting portion of the heat dissipating frame to cover the LED module and having a boring hole formed at a location corresponding to an emission surface of the LED element; a frame cover coupled to be attached to and detached from the bottom of the heat dissipating frame; and a diffusion cover mounted on the side reflecting portion of the heat dissipating frame and having a toothed diffusion lens serving as refraction and diffusion operations installed on the inner periphery thereof, wherein at least one housing hole is formed on the housing cover.

An embodiment of the present invention provides a line-shaped LED lighting device including: a base frame partitioned into an upper space part and a lower space part, having a bent side wall, and having at least one frame ventilation hole formed on the side wall; an LED module installed in the upper space part of the base frame and having an LED element; a curved reflecting plate in which the end is supported on the upper space part of the base frame, a boring hole is formed at a location corresponding to an emission surface of the LED element, and a diffusion lens is installed on a straight line with the LED module; a diffusion plate fixed to the top of the base frame; a side cover coupled to the side of the base frame and connecting a power to the LED module; and a power supply module unit coupled to the side cover to supply the power to the LED module, wherein a toothed diffusion lens performing refraction and diffusion operations is installed on the diffusion plate.

An embodiment of the present invention provides a panel-shaped LED lighting device including: a heat dissipating plate in which recessed portions and projected portions are continuously formed and light source mounting grooves are formed in the projected portions; a power supply controller installed on the heat dissipating plate; an LED module mounted in the light source mounting groove of the heat dissipating plate and electrically connected to the power supply controller to flicker by a control from the power supply controller; a reflecting plate in which curved reflecting portions coupled to a front surface of the heat dissipating plate and having a downward semicircular cross section are continuously formed and a boring hole is formed on the bottom of the curved reflecting portion; a semicircular diffusion lens installed on the front bottom of the curved reflecting portion to cover the boring hole of the curved reflecting portion; and a diffusion plate coupled to the front surface of the reflecting plate to cover the front surface of the reflecting plate.

### [Effect of Invention]

An embodiment of the present invention can provide a lamp type LED lighting device that can rapidly discharges heat generated from an LED element that influences an optical output and a lifespan of the LED lighting device through a lamp type frame having a convection heat dissipation structure in which ventilation is smooth, and prevent an LED light source from glaring and widely diffuse a light source without optical attenuation by using a side reflection member and a diffusion lens and a diffusion cover.

Another embodiment of the present invention can provide line type and panel type LED lighting devices that can replace the existing fluorescent lamp and panel type lighting device by rapidly discharging heat generated from an LED element that influences an optical output and a lifespan of the LED lighting device through a frame having smooth line type and panel type structures in which a heat dissipating operation is smooth, and preventing an LED light source from glaring and widely diffusing a light source without optical attenuation by optically placing a curved reflection plate with a diffusion lens and a diffusion plate and a diffusion window.

### DESCRIPTION OF DRAWINGS

FIG. 1 is a perspective view of a lamp-shaped LED lighting device according to an embodiment of the present invention;

FIG. 2 is an exploded perspective view of the lamp-shaped LED lighting device shown in FIG. 1;

FIG. 3 is a cross-sectional view take along line m-m shown in FIG. 1;

FIG. 4 is a modified cross-sectional view of a heat dissipating frame adopted in the lamp-shaped LED lighting device shown in FIG. 1;

FIG. 5 is a perspective view of an LED module adopted in the lamp-shaped LED lighting device shown in FIG. 1;

FIG. 6 is a bottom view of a frame cover adopted in the lamp-shaped LED lighting device shown in FIG. 1;

FIG. 7 is a block diagram of an optical sensor and a power supply module and an LED module and a control unit adopted in the lamp-shaped LED lighting device shown in FIG. 1;

FIGS. 8 to 10 are usage state diagrams of the lamp-shaped LED lighting device shown in FIG. 1;

FIG. 11 is a perspective view showing a state in which a diffusion cover is coupled to the lamp-shaped LED lighting device shown in FIG. 1;

FIG. 12 is a usage state diagram of the state in which the diffusion cover is coupled to the lamp-shaped LED lighting device shown in FIG. 1;

FIG. 13 is a front view of a lamp-shaped LED lighting device according to another embodiment of the present invention;

FIG. 14 is a cross-sectional view take along line XII-XII shown in FIG. 13;

FIG. 15 is a perspective view of a line-shaped LED lighting device according to an embodiment of the present invention;

FIG. 16 is an exploded perspective view of the line-shaped LED lighting device shown in FIG. 15;

FIG. 17 is a cross-sectional view taken along line of FIG. 15;

FIG. 18 is a perspective view of an LED module adopted in the line-shaped LED lighting device shown in FIG. 15;

FIG. 19 is a plan view showing a state in which a diffusion lens of a curved reflecting plate and a diffusion plate and a diffusion window and a power supply module unit from the line-shaped LED lighting device shown in FIG. 15;

FIG. 20 is a front cross-sectional view showing diffusion and refraction operations of the line-shaped LED lighting device shown in FIG. 15;

FIGS. 21 to 22 are usage state diagrams of the line-shaped LED lighting device shown in FIG. 15;

FIG. 23 is a perspective view of a panel-shaped LED lighting device according to the present invention;

FIG. 24 is a side view of a panel-shaped LED lighting device according to the present invention;

FIG. 25 is an exploded perspective view of a panel-shaped LED lighting device according to the present invention;

FIG. 26 is a perspective view of an LED module in the panel-shaped LED lighting device according to the present invention;

FIG. 27 is a plan view of a reflecting plate in the panel-shaped LED lighting device according to the present invention;

FIG. 28 is a diagram showing light diffusion of an LED light source in the panel-shaped LED lighting device according to the present invention; and

FIG. 29 is a schematic structural diagram of a large surface lighting device implemented by connecting four panel-shaped LED lighting devices according to the present invention in a horizontal direction and a vertical direction.

### BEST MODE

An embodiment of the present invention provides a lamp-shaped LED lighting device including: a housing cover having a socket fixed at one side thereof; a heat dissipating frame fixed to the other side of the housing cover, having at least three side reflecting portions formed on the outer peripheral surface thereof, and a ventilation unit having at least one ventilation hole formed at a portion which the end of the side reflecting portion contacts; an LED module fixed to the side reflecting portion of the heat dissipating frame and having an LED element; a power supply module unit installed in the heat dissipating frame; a side reflecting member fixed to the side reflecting portion of the heat dissipating frame to cover the LED module and having a boring hole formed at a location corresponding to an emission surface of the LED element; a frame cover coupled to be attached to and detached from the bottom of the heat dissipating frame; and a diffusion cover mounted on the side reflecting portion of the heat dissipating frame and having a toothed diffusion lens serving as refraction and diffusion operations installed on the inner periphery thereof, wherein at least one housing hole is formed on the housing cover.

An embodiment of the present invention provides a lamp-shaped LED lighting device including: a housing cover having a socket fixed at one side thereof; a power supply module housing coupled to be attached to and detached from the other side of the housing cover; a heat dissipating frame fixed to one side of the power supply module housing, having at least three side reflecting portions formed on the outer peripheral surface thereof, and a ventilation unit having at least one ventilation hole formed at a portion which the end of the side reflecting portion contacts; an LED module fixed to the side reflecting portion of the heat dissipating frame and having an LED element; a power supply module unit installed in the power supply module housing; a side reflecting member fixed to the side reflecting portion of the heat dissipating frame to cover the LED module and having a boring hole formed at a location corresponding to an emission surface of the LED element; a frame cover coupled to be attached to and detached from the bottom of the heat dissipating frame; and a diffusion cover mounted on the side reflecting portion of the heat dissipating frame and having a toothed diffusion lens serving as refraction and diffusion operations installed on the inner periphery thereof, wherein at least one housing hole is formed on the housing cover.

The embodiment of the present invention provides the lamp-shaped LED lighting device in which an optical sensor is installed at one side of the frame cover.

The embodiment of the present invention provides the lamp-shaped LED lighting device in which a diffusion lens diffusing a light source emitted from the LED module is installed in the side reflecting member.

The embodiment of the present invention provides the lamp-shaped LED lighting device in which a control unit controlling illumination of the LED module is installed in the power supply module unit.

The embodiment of the present invention provides the lamp-shaped LED lighting device in which a prism is formed in the diffusion lens of the side reflecting member.

The embodiment of the present invention provides the lamp-shaped LED lighting device in which at least one frame cover hole is formed in the frame cover.

The embodiment of the present invention provides the lamp-shaped LED lighting device in which the toothed diffusion lens of the diffusion cover is formed by a Fresnel lens.

The embodiment of the present invention provides the lamp-shaped LED lighting device in which the side reflecting member is plated with chrome or nickel.

The embodiment of the present invention provides the lamp-shaped LED lighting device in which a dome-shaped reflecting mirror is installed at the center of the frame cover and an LED lamp is installed in the reflecting mirror.

The embodiment of the present invention provides the lamp-shaped LED lighting device in which the LED module is replaceable by the side reflecting member and the frame cover separated from the heat dissipating frame.

An embodiment of the present invention provides a line-shaped LED lighting device including: a base frame partitioned into an upper space part and a lower space part, having a bent side wall, and having at least one frame ventilation hole formed on the side wall; an LED module installed in the upper space part of the base frame and having an LED element; a curved reflecting plate in which the end is supported on the upper space part of the base frame, a boring hole is formed at a location corresponding to an emission surface of the LED element, and a diffusion lens is installed on a straight line with the LED module; a diffusion plate fixed to the top of the base frame; a side cover coupled to the side of the base frame and connecting a power to the LED module; and a power supply module unit coupled to the side cover to supply the power to the LED module, wherein a toothed diffusion lens performing refraction and diffusion operations is installed on the diffusion plate.

The embodiment of the present invention provides the line-shaped LED lighting device further including a diffusion window fixed to the top of the base frame to cover the diffusion plate.

The embodiment of the present invention provides the line-shaped LED lighting device further including a frame supporting unit coupled to be attached to and detached from the base frame and having at least one heat dissipating pin and a ventilation hole formed on the side wall.

The embodiment of the present invention provides the line-shaped LED lighting device in which an optical sensor and a control unit are installed in the power supply module unit and the control unit is connected with the power supply module unit and the optical sensor to automatically control illumination of the LED module.

The embodiment of the present invention provides the lamp-shaped LED lighting device in which a prism is formed in the diffusion lens of the curved reflecting plate.

The embodiment of the present invention provides the lamp-shaped LED lighting device in which a lenticular lens is installed in the diffusion window.

The embodiment of the present invention provides the lamp-shaped LED lighting device in which a diffusion prism is further installed in the diffusion plate.

The embodiment of the present invention provides the lamp-shaped LED lighting device in which the curved reflecting plate is plated with chrome or nickel.

An embodiment of the present invention provides a panel-shaped LED lighting device including: a heat dissipating plate in which recessed portions and projected portions are continuously formed and light source mounting grooves are formed in the projected portions; a power supply controller installed on the heat dissipating plate; an LED module mounted in the light source mounting groove of the heat dissipating plate and electrically connected to the power supply controller to flicker by a control from the power supply controller; a reflecting plate in which curved reflecting portions coupled to a front surface of the heat dissipating plate and having a downward semicircular cross section are continuously formed and a boring hole is formed on the bottom of the curved reflecting portion; a semicircular diffusion lens installed on the front bottom of the curved reflecting portion to cover the boring hole of the curved reflecting portion; and a diffusion plate coupled to the front surface of the reflecting plate to cover the front surface of the reflecting plate.

The embodiment of the present invention provides the panel-shaped LED lighting device further including connectors provided on sides of the heat dissipating plate, which enable extension to a large surface lighting device through power supply connection and interconnections of the LED lighting devices by being electrically connected to the power supply controllers.

The embodiment of the present invention provides the panel-shaped LED lighting device in which in the LED module, a plurality of LED elements are spaced apart from each other on a bar-type printed circuit board and connection terminals for electrically connecting the power supply controller are provided at one side thereof.

The embodiment of the present invention provides the panel-shaped LED lighting device in which the LED module is replaceably mounted in the light source mounting groove.

The embodiment of the present invention provides the panel-shaped LED lighting device in which boring holes are formed at only locations of the curved reflecting portion of the reflecting plate corresponding to the LED elements so that only light sources of the LED elements arranged in the LED module are projected onto the reflecting plate and the boring holes of the reflecting plate are supported in contact with the periphery of the emission surface of the LED element at the time of coupling the reflecting plate.

The embodiment of the present invention provides the panel-shaped LED lighting device in which the reflecting plate is manufactured by forming a metal plate so that the curved reflecting portions are continuously formed and plating the surface thereof with chrome or nickel.

The embodiment of the present invention provides the panel-shaped LED lighting device in which an inverted triangular lens surface having a prism shape performing a full-reflection operation is formed on the inner surface of the semicircular diffusion lens.

The embodiment of the present invention provides the panel-shaped LED lighting device in which a prism-type toothed diffusion lens is formed on the bottom of the diffusion plate corresponding to the LED module.

The embodiment of the present invention provides the panel-shaped LED lighting device in which as the panel-shaped LED lighting device is formed in a square shape and the connectors are provided at the centers of the sides one at a time, grid-shaped power supply circuits are implemented between the power supply controller and the connectors at the center and in the case where the panel-shaped LED lighting devices are connected to each other in horizontal and vertical directions by using the connectors to extend to the large surface lighting device, a general net type power supply circuit is implemented by power supply circuits.

### [Mode for Invention]

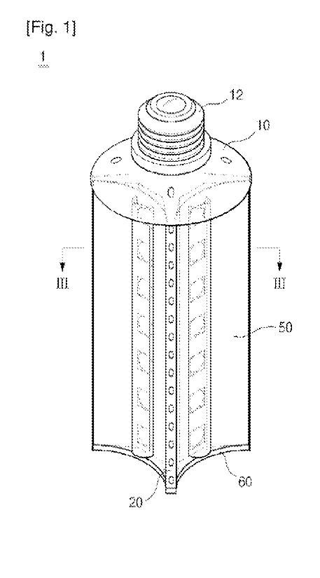

A lamp type LED lighting device according to an embodiment of the present invention includes a housing cover 10, a heat dissipating frame 20, an LED module 30, a power supply module unit 40, a side reflecting member 50, a frame cover 60, a light sensor 70, and a control unit 80 as shown in FIGS. 1 to 14.

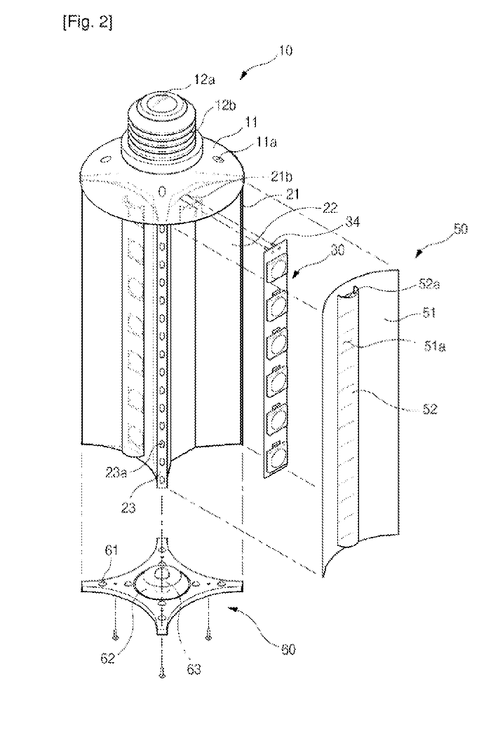

The housing cover 10 preferably has a disk shape and includes a housing 11, having at least one housing hole 11a and a socket 12 fixed to the top of the housing 11 and connected with an external power supply as shown in FIGS. 1 and 2.

The housing hole 11a serves as a movement passage of air that allows heat generated from the LED module 30 to be described later to be discharged and cooled by air. The socket 12 includes a positive electrode connection terminal 12a and a negative electrode connection terminal 12b to supply a power to the power supply module unit 40 to be described later as shown in FIG. 2.

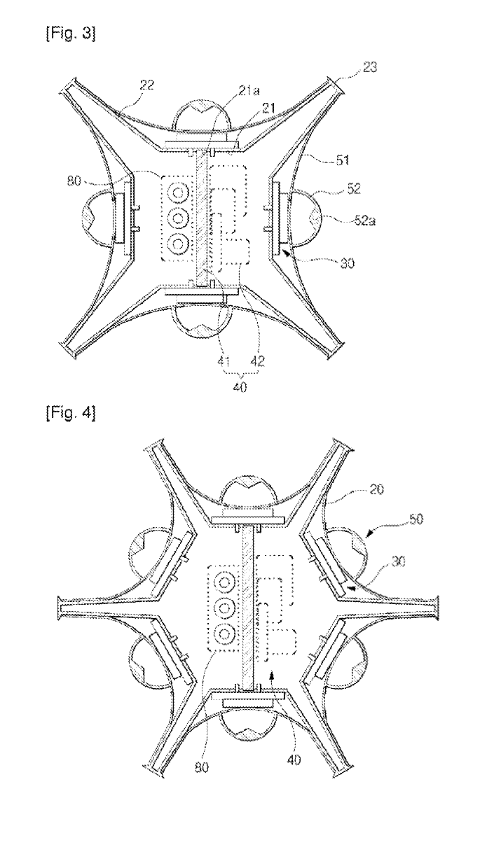

The heat dissipating frame 20 includes a frame body 21 that is hollow and preferably has a radial shape to make convection heat dissipation smooth, at least three side reflecting units 22 formed outside the frame body 21, and a ventilation unit 23 formed at a portion where the end of the side reflecting unit 22 contacts as shown in FIGS. 2 and 3.

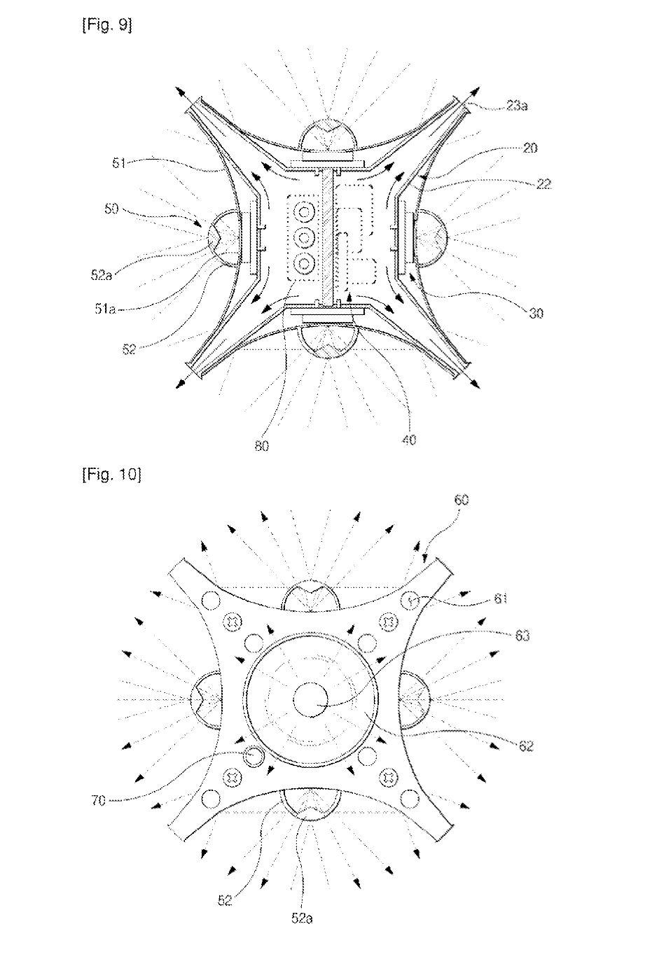

Inside the frame body 21, a power supply module fixing groove 21a which the power supply module unit 40 to be described later slides to be inserted into and fixed to is formed as shown in FIG. 3 and outside of the frame body 21, a ground hole 21b which the LED connection terminal 34 of the LED module 30 to be described later is inserted into and fixed to is formed as shown in FIG. 2. The ground hole 21b is connected with the power supply module unit 40 to be described later. Since an inner part of the frame body 21 is hollow, the inner part serves as a movement passage of air (see FIG. 9) to cool heat generated from the LED module 30 to be described later. The frame body 21 can be transformed to various types of polygonal shapes on the basis of the shape of FIG. 3 as shown in FIG. 4.

The side reflecting unit 22 is a location where the side reflecting member 50 is installed as shown in FIG. 3 and the end of the side reflecting unit 22 is preferably bent to support the side reflecting member 50.

The ventilation unit 23 allows heat generated from the power supply module unit 40 and the LED module 30 to be described later to be rapidly discharged to the outside and at least one ventilation hole 23a is preferably formed in the ventilation unit 23 as shown in FIG. 2.

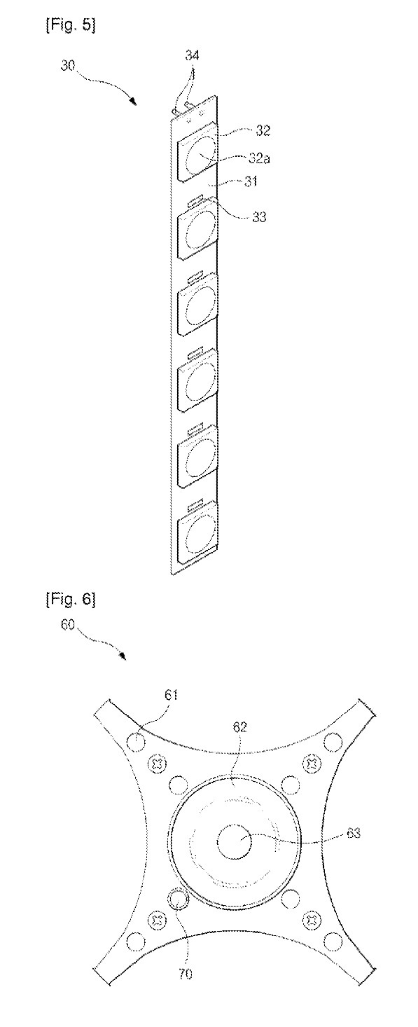

The LED module 30 is preferably installed outside the heat dissipating frame 20 as shown in FIG. 2 and connected with the power supply module unit 40 to be described later to emit an LED light source. The LED module 30 includes a module base 31, at least one LED element 32 fixed to one side of the module base 31 and having an LED emission surface 32a, a resistor 33 installed between the LED elements 32, and an LED connection terminal 34 installed at one side of the module base 31 and inserted into the ground hole 21b of the heat dissipating frame 20 as shown in FIG. 5.

On the LED emission surface 32a of the LED element 32, the periphery of the boring hole 51a of the side reflecting member 50 to be described later is preferably supported to allow heat accumulated on the LED emission surface 32a to be absorbed in the side reflecting member 50 as shown in FIG. 3.

The power supply module unit 40 includes a power supply module PCB 41 sliding-inserted into a power supply module fixing groove 21a of the heat dissipating frame 20 and a power supply module 42 fixed to the power supply module PCB 41 and converting AC power applied through the socket 12 as shown in FIG. 3.

The side reflecting member 50 is mounted on the side reflecting unit 22 of the heat dissipating frame 20 to diffuse and refract the light source emitted from the LED module 30 as shown in FIGS. 2 and 3. The side reflecting member 50 includes a base plate 51 fixed to both ends of the side reflecting member 22 and having at least one boring hole 51a formed at a location thereof corresponding to the LED element 32 and a diffusion lens 52 installed in the base plate 51 to be positioned on a straight line with the LED element 32 as shown in FIG. 3.

The periphery of the boring hole 51a of the base plate 51 is preferably supported on the LED emission surface 32a to absorb heat accumulated on the LED emission surface 32a as described above.

A prism 52a is formed in the diffusion lens 52 to full-reflect (see FIG. 9) the light source generated from the LED module 30 as shown in FIG. 3. The full-reflection represents a phenomenon in which when light is progressed from a material having optically large refractivity to a material having optically small refractivity, light incident at an incident angle larger than a predetermined threshold angle is not refracted but fully reflected and the minimum value of the incident angle at which the full-reflection may occur is referred to as the threshold angle. For example, a threshold angle at which light is progressed from glass to air is 42 degrees and if the incident angle is larger than 42 degrees, light cannot transmit the glass and is fully reflected on the inner surface of the glass not to be progressed to air. The phenomenon is referred to as the full-reflection and the full-reflection prism 52a uses such a property.

The side end of the side reflecting member 50 is supported on the end of the side reflecting unit 22 as shown in FIG. 3 and the top thereof is supported on the bottom of the housing 11 as shown in FIG. 2. The bottom of the side reflecting member 50 is supported on the frame cover 60 to be described later as shown in FIG. 1. That is, the side reflecting member 50 can be separated by attaching and detaching the frame cover 60, and as a result, the LED module 30 having reduced illumination can be easily replaced.

The surface of the side reflecting member 50 is preferably plated with chrome or nickel in order to improve reflection and diffusion efficiencies.

The frame cover 60 is coupled to be attached to and detached from the bottom of the heat dissipating frame 20 as shown in FIG. 2, and as a result, the LED module 30 and the power supply module unit 40 can be easily replaced. At least one frame cover hole 61 is formed in the frame cover 60 as shown in FIGS. 2 and 6, a dome-shaped reflecting mirror 62 is installed at the center of the frame cover 60, and a circular LED lamp 63 connected with the power supply module unit 40 is coupled to the reflecting mirror 62.

The optical sensor 70 is preferably installed on the bottom of the frame cover 60 as shown in FIG. 6 and senses the amount of surrounding light and transfers a signal to the control unit 80 installed in the power supply module unit 40. The control unit 80 controls the illumination of the LED module 30 by the signal transferred from the optical sensor 70 as shown in FIG. 7. Since the above-mentioned controlling method employs the related art, a detailed description thereof will be omitted.

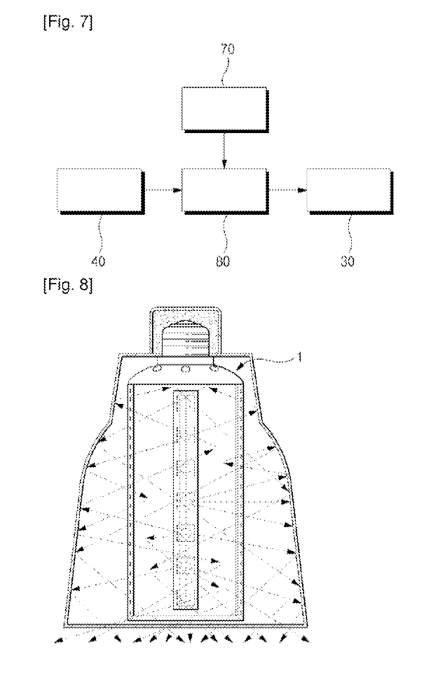

FIG. 8 is a diagram showing a usage state of the lamp-shaped LED lighting device shown in FIG. 1. In detail, FIG. 8 shows a usage state of a lamp-shaped LED lighting device used in a ceiling mounted type.

The light source generated from the LED module 30 is diffused to surrounding areas by the diffusion lens 52 as shown in FIG. 9 and some light sources are full-reflected by the prism 52a. The full-reflected or diffused light source forms multiple reflections by a reflection surface of a ceiling mounted lamp device buried in a ceiling, and the like and is irradiated to the outside to become soft downlight lighting as shown in FIG. 8.

In this case, heat generated from the LED module 30 is cooled by external air inputted through the frame cover hole 61 formed in the frame cover 60 and is rapidly discharged to the outside through the ventilation hole 23a formed in the ventilation unit 23 as shown in FIG. 10. Furthermore, since the periphery of the boring hole 51a of the base plate 51 is supported on the LED emission surface 32a of the LED element 32, the heat accumulated on the LED emission surface 32a is transferred to the base plate 51 on the periphery of the boring hole 51a to acquire a cooling effect.

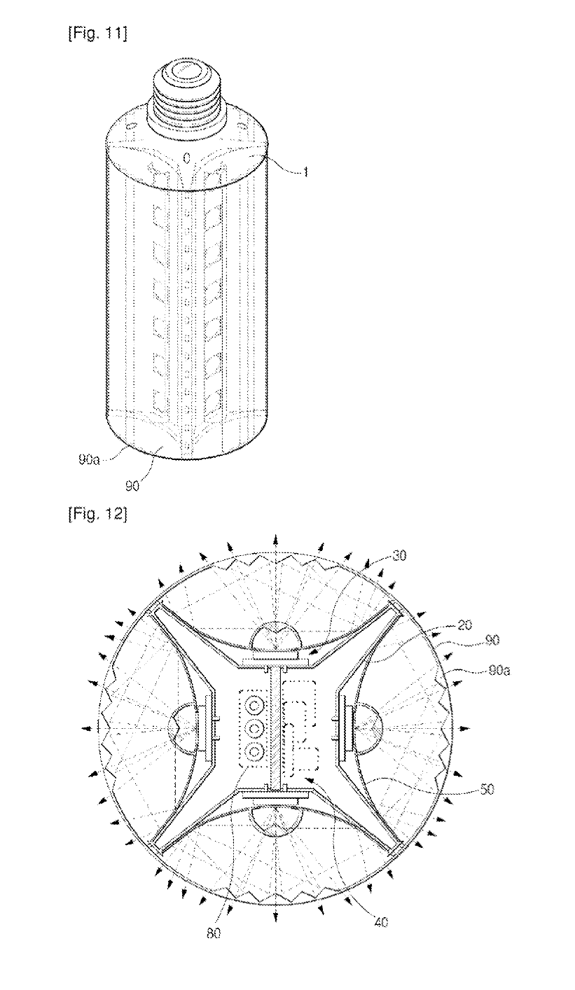

FIG. 11 is a perspective view showing a state in which a diffusion cover is coupled to the lamp type LED lighting device shown in FIG. 1 and FIG. 12 is a usage state diagram showing a state in which the diffusion cover is coupled to the lamp type LED lighting device shown in FIG. 1.

The diffusion cover 90 is preferably fitted in a protrusion formed in the heat dissipating frame 20 as shown in FIGS. 11 and 12 and the diffusion cover 90 is used when the lamp type LED lighting device according to the embodiment of the present invention is not mounted on the ceiling lighting device, but is exposed to the outside as an independent lighting lamp.

A toothed diffusion lens 90a opposed to the side reflecting member 50 and having a full-reflection characteristic is installed inside the diffusion cover 90 as shown in FIG. 12. The toothed diffusion lens 90a allows diffused light of the LED light source to be reflected in a semicircular form by mutual reflection operations with the side reflecting member 50. The toothed diffusion lens 90a is preferably manufactured by a Fresnel lens type lens processing method for efficient refraction and diffusion operations.

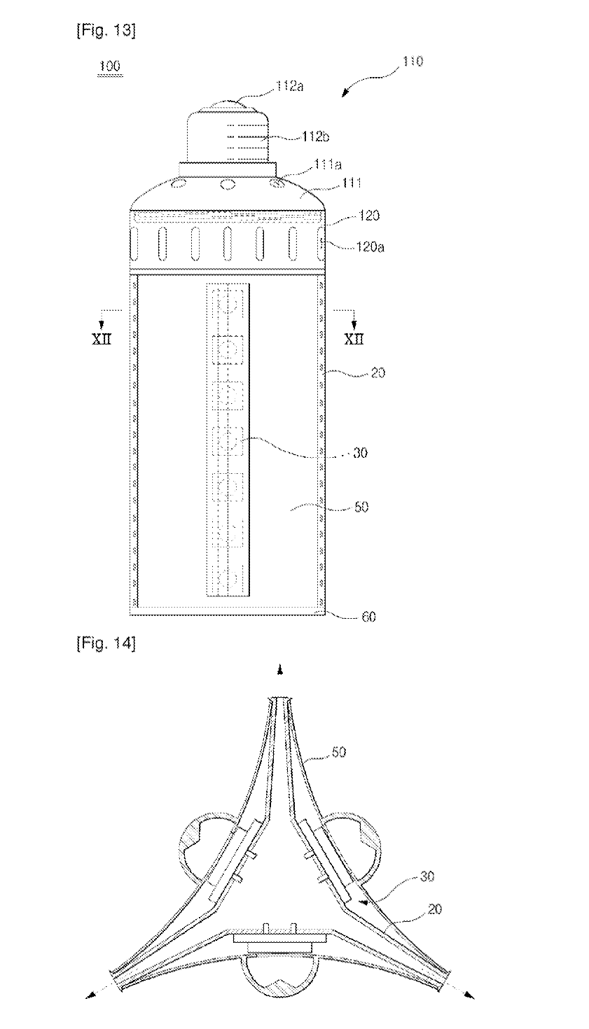

FIG. 13 is a front view of a lamp-shaped LED lighting device according to another embodiment of the present invention and FIG. 14 is a cross-sectional view taken along line XH-XH shown in FIG. 13.

The lamp-shaped LED lighting device 100 according to another embodiment of the present invention includes a housing cover 110, a power supply module housing 120, a heat dissipating frame 20, an LED module 30, a power supply module unit 40, a side reflecting member 50, a frame cover 60, an optical sensor 70, a control unit 80, and a diffusion cover 90. Herein, the same reference numerals in the figures shown in above refer to the same members having the same function.

The housing cover 110 is coupled to be attach to and detached from the power supply module housing 120 to be described later as shown in FIG. 13 and preferably has a semicircular shape and includes a housing 111 having at least one housing hole 111a and a socket 112 fixed to the top of the housing 111 and connected with an external power supply.

The housing hole 11a serves as a movement passage of air that allows heat generated from the LED module 30 to be described later to be cooled by air. The socket 112 includes a positive electrode connection terminal 112a and a negative electrode connection terminal 112b as shown in FIG. 13 to supply a power to the power supply module unit 40.

The power supply module housing 120 is coupled to be attached to or detached from the bottom of the housing cover 110 and the power supply module unit 40 is installed inside the power supply module housing 120 to be separated. The power supply module unit 40 is installed in the power supply module housing 120 in the same method as the installation method in the heat dissipating frame 20.

At least one of the module housing holes 120a serving as an intake passage of air is formed in the power supply module housing 120 to rapidly cool heat generated from the LED module 30 and the power supply module unit 40 by air circulation.

A line-shaped LED lighting device 200 according to an embodiment of the present invention includes a base frame 210, an LED module 220, a curved reflecting plate 230, a diffusion plate 240, a diffusion window 250, a side cover 260, a power supply module unit 270, an optical sensor 280, a frame supporting unit 290, and a control unit (not shown) as shown in FIGS. 15 to 22.

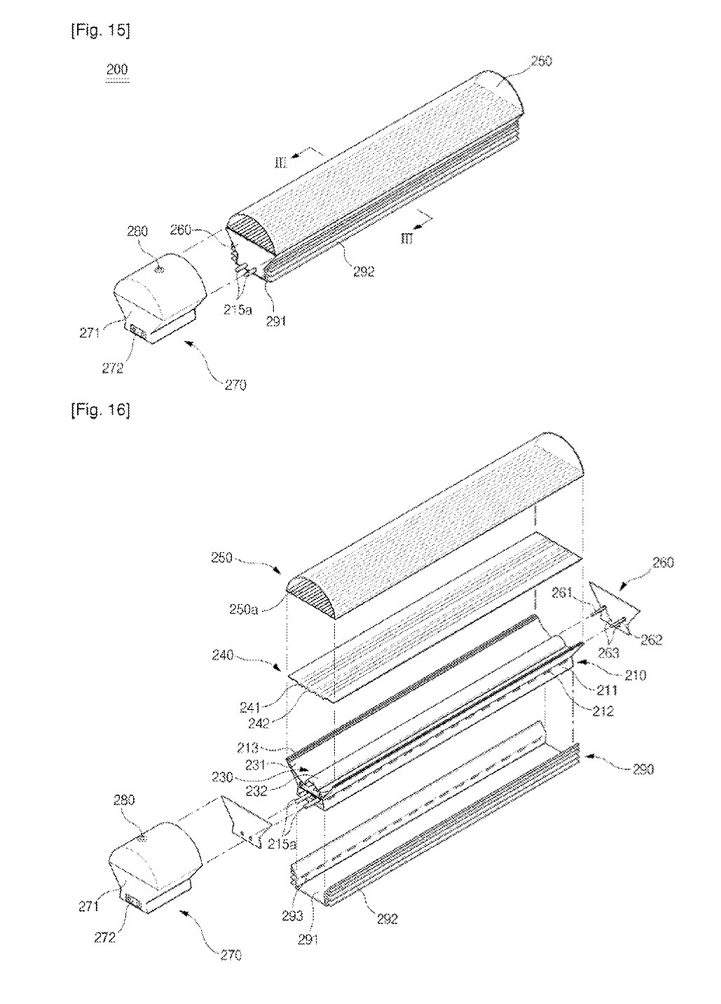

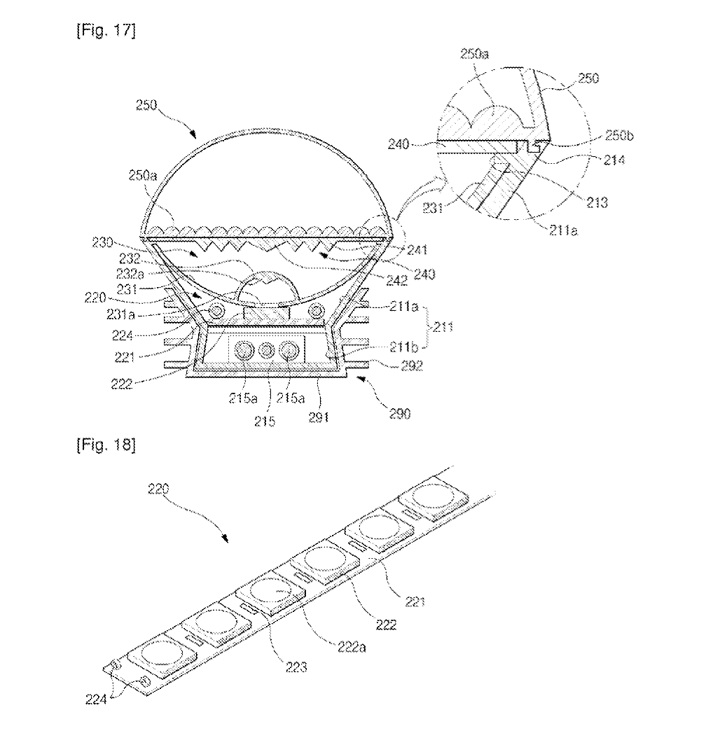

The base frame 210 includes a frame body 211 that is partitioned into an upper space part 211a and a lower space part 211b and has a bent side wall, at least one frame ventilation hole 212 formed on the side wall of the frame body 211, a supporting protrusion 213 formed on the top of the frame body 211 and supporting the curved reflecting plate 230 and the diffusion plate 240 to be described later, and a diffusion window supporting groove 214 formed on the top of the frame body 211 and fixing the diffusion window 250 to be described later as shown in FIGS. 16 and 17.

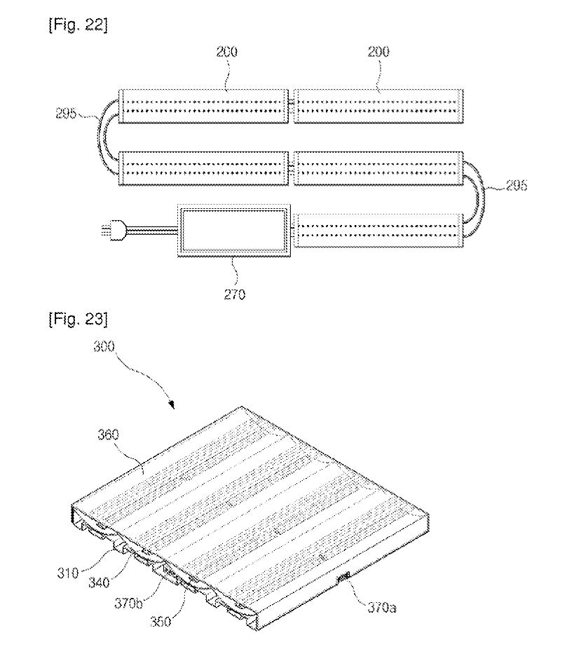

Further, a power supply connecting unit 215 in which a projection-type connection terminal 215a is formed at one side and an insertion-type connection terminal (not shown) is formed at the other side is installed in the lower space part 211b of the base frame 210 as shown in FIG. 17. The projection-type connection terminal 215a is connected to the power supply module unit 270 to be described later to connect a power supply to the LED module 220 as shown in FIG. 15. The insertion-type connection terminal is used when two line-shaped LED lighting devices 200 according to the embodiment of the present invention are connected to each other (see FIG. 22).

The LED module 220 is installed in the upper space part 211a of the frame body 211 as shown in FIG. 17 and connected to the power supply module unit 270 to be described later to emit the LED light source. The LED module 220 includes a module base 221 installed on the bottom of the upper space part 211a of the frame body 211, at least one LED element 222 fixed to one side of the module base 221 and having an LED emission surface 222a, a resistor 223 installed between the LED elements 222, and an LED connection terminal 224 installed at one side of the module base 221, which an LED power supply connection terminal 261 and a common terminal 262 of the side cover 260 are inserted into and fixed to.

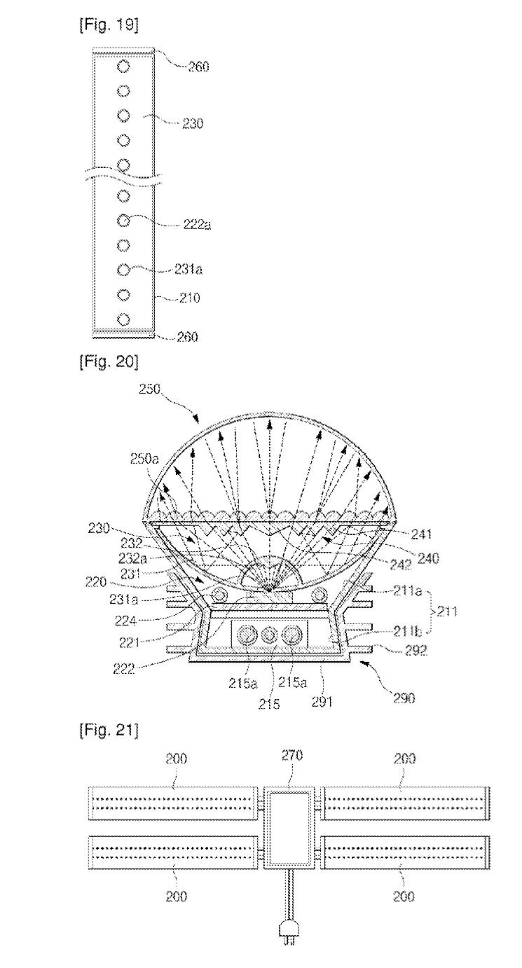

On the LED emission surface 222a of the LED element 222, the periphery of the boring hole 231a of the side reflecting member 230 to be described later is preferably supported to allow heat accumulated on the LED emission surface 222a to be absorbed in the side reflecting member 230 as shown in FIG. 19.

The curved reflecting plate 230 is installed in the upper space part 211a of the base frame 210 to diffuse and refract a light source emitted from the LED module 220 as shown in FIGS. 16 and 17. The curved reflecting plate 230 includes a base plate 231 of which both ends are supported on the supporting protrusion 213 of the base frame 210 and where at least one boring hole 231a is formed at a location thereof corresponding to the LED element 222 and a diffusion lens 232 installed in the base plate 231 to be positioned on a straight line with the LED element 222 as shown in FIG. 17.

The periphery of the boring hole 231a of the base plate 231 is preferably supported on the LED emission surface 222a to absorb heat accumulated on the LED emission surface 222a as shown in FIG. 19. A light source emitted from the top of the LED element 222 is absorbed in constituent components of the LED module 220 or the base frame 210 to prevent light from being attenuated. Further, heat emitted from the top of the LED element 222 can be rapidly discharged through the bottom of the curved reflecting plate 230 supported on the periphery of each LED emission surface 222a.

A prism 232a is formed in the diffusion lens 232 to full-reflect the light source generated from the LED module 220 as shown in FIG. 17. The full-reflection represents a phenomenon in which when light is progressed from a material having optically large refractivity to a material having optically small refractivity, light incident at an incident angle larger than a predetermined threshold angle is not refracted but fully reflected and the minimum value of the incident angle at which the full-reflection may occur is referred to as the threshold angle. For example, a threshold angle at which light is progressed from glass to air is 42 degrees and if the incident angle is larger than 42 degrees, light cannot transmit the glass and is fully reflected on the inner surface of the glass not to be progressed to air. The phenomenon is referred to as the full-reflection and the full-reflection prism 232a uses such a property.

The surface of the curved reflecting member 230 is preferably plated with chrome or nickel in order to improve reflection and diffusion efficiencies.

The end of the diffusion plate 240 is supported on the supporting protrusion 213 of the base frame 210 and a toothed lens 241 and a diffusion prism 242 are formed on a surface the diffusion plate 240 opposed the diffusion lens 232 in order to improve reflection and diffusion efficiencies as shown in FIG. 17.

It is preferable to insert a color sheet (not shown) between the diffusion plate 240 and the diffusion window 250 to be described later to express soft color lighting depending on a lighting usage.

The diffusion window 250 is preferably fixed to a diffusion window supporting groove 214 of the base frame 210 by a diffusion window supporting protrusion 250b and a lenticular lens 250a in which a plurality of plano-convex lenses are arranged in parallel is installed on the inner bottom of the diffusion window 250 as shown in FIG. 17. The lenticular lens 250a allows refraction and reflection to be more variously made in the diffusion window 250 to implement an efficient diffusion operation. It is preferable that an ivory white diffusion material is included in the diffusion window 250 in order to acquire softer lighting.

The diffusion window 250 may be selectively used depending on a lighting usage. That is, the diffusion window 250 is removed and only the diffusion plate 240 may be used depending on a usage of the lighting device. In this case, the diffusion plate 240 is preferably coupled to the supporting protrusion 213 of the base frame 210 by using a screw or an appropriate supporting member in order to improve fixity.

The side cover 260 is preferably screwed or fitted in the side of the base frame 210 to be attached and detached as shown in FIG. 16. The LED power supply connection terminal 261 and the common terminal 262 are mounted on the inner part of the side cover 260 and terminal holes 263 connected with the LED power supply connection terminal 261 and the common terminal 262 are formed in the inner part of the side cover 260.

The side cover 260 serves to connect a power inputted from the power supply module unit 270 to be described later to the LED module 220. In detail, the power inputted from the power supply module unit 270 is connected to the terminal hole 263 of the side cover 260 by the projection-type connection terminal 215a of the base frame 210. The terminal hole 263 is connected to the LED power supply connection terminal 261 and the common terminal 262 and since the LED power supply connection terminal 261 and the common terminal 262 are inserted into and fixed to the LED connection terminal 224 of the LED module 220, the power inputted from the power supply module unit 270 is supplied to the LED module 220.

As described above, in the line-shaped LED lighting device 200 according to the embodiment of the present invention, since a plurality of LED lighting devices can be connected to each other in series without additional connection wires by using a power connection method through the side cover 260, the lighting device can easily and simply established.

Further, in the line-shaped LED lighting device 200 according to the embodiment of the present invention, when the illumination deteriorates, the LED module 220 can be easily replaced by separating the side cover 260 from the base frame 210. As a result, the line-shaped LED lighting device 200 according to the embodiment of the present invention is used semipermanently, to thereby mitigate the dissipation of resources and contribute to environmental protection.

The power supply module unit 270 includes a power supply module housing 271 fixed to the LED power supply connection terminal 261 of the side cover 260, an AC inlet 272 installed at one side of the power supply module housing 271 and allowing an external power to be introduced, and a power supply module (not shown) converting the applied AC power as shown in FIGS. 15 to 17.

The optical sensor 280 is installed at one side of the power supply module unit 270 as shown in FIG. 15 and senses the amount of surrounding light to transfer a signal to a control unit (not shown) installed in the power supply module unit 270. The control unit controls the illumination of the LED module 220 by using the signal transferred from the optical sensor 280. Since the above-mentioned controlling method employs the related art, a detailed description thereof will be omitted.

The frame supporting unit 290 includes a frame supporting body 291 coupled to be attach to and detached from the bottom of the base frame 210, at least one heat dissipating pin 292 fixed to the side of the frame supporting body 291, and at least one ventilation hole 293 formed on the side of the frame supporting body 291 to communicated with the frame ventilation hole 212 of the base frame 210 as shown in FIGS. 15 and 16.

The heat dissipating pin 292 discharges heat generated by the LED element 222 and accumulated in the base frame 210 to the outside. Further, the heat generated from the LED element 222 passes through the lower space part 211b which is a lower heat dissipating space of the base frame 210 and is easily discharged to the outside through the frame ventilation hole 212 and the ventilation hole 293 of the frame supporting unit 290 by ventilation. As a result, the heat of the LED element 222 may be discharged more rapidly than that of the known LED lighting device.

Further, since the frame supporting unit 290 supports the base frame 210, the base frame 210 may be manufactured more simply and economically and the frame supporting unit 290 may be efficiently used as a mounting stand at the time of installing or connecting the lighting device.

FIG. 20 is a front cross-sectional view showing diffusion and refraction operations of the line-shaped LED lighting device shown in FIG. 15.

The light source generated from the LED module 220 is diffused to surrounding areas by the diffusion lens 232 as shown in FIG. 20 and some light sources are full-reflected by the prism 232a. The full-reflected or diffused light source forms semicircular reflection by the base plate 231 of the curved reflecting plate 230. The semicircular light source is refracted and reflected more variously by the lenticular lens 250a of the diffusion window 250 to be discharged to the outside.

In this case, the heat generated from the LED element 220 passes through the lower space part 211b which is the lower heat dissipating space of the base frame 210 and is rapidly discharged to the outside through the frame ventilation hole 212 and the ventilation hole 293 of the frame supporting unit 290. Furthermore, since the periphery of the boring hole 231a of the base plate 231 is supported on the LED emission surface 222a of the LED element 222, the heat accumulated on the LED emission surface 222a is transferred to the base plate 231 on the periphery of the boring hole 231a to acquire a cooling effect.

FIGS. 21 to 22 are usage state diagrams of the line-shaped LED lighting device shown in FIG. 15.

FIG. 21 shows a high-luminance lighting device by mounting four line-shaped LED lighting devices 200 according to an embodiment of the present invention on one power supply module unit 270. As described above, in the case of the line-shaped LED lighting devices 200 according to the embodiment of the present invention, it is possible to acquire a desired light amount by connecting one or more line-shaped LED lighting devices 200 to one power supply module unit 270 depending on a lighting usage. Further, in the line-shaped LED lighting device 200 according to the embodiment of the present invention, when the illumination deteriorates, the LED module 220 is separated from he power supply module unit 270 to be easily replaced, the line-shaped LED lighting device 200 may be used semipermanently.

FIG. 22 is a diagram showing a case in which five line-shaped LED lighting devices 200 are connected to one power supply module unit 270 in series and for convenience of a drawing space, a partial connection section of the line-shaped LED lighting device 200 is displayed as an additional power supply connector 295. When the line-shaped LED lighting device 200 according to the embodiment of the present invention elongates in a straight direction, the projection-type connection terminal 215a is connected to an insertion terminal (not shown) of another adjacent line-shaped LED lighting device 200, and as a result, an additional extending power supply connector 295 is not required.

The line-shaped LED lighting device 200 according to the embodiment of the present invention may be used in various forms by using modifying the method of using the lighting device shown in FIGS. 21 and 22.

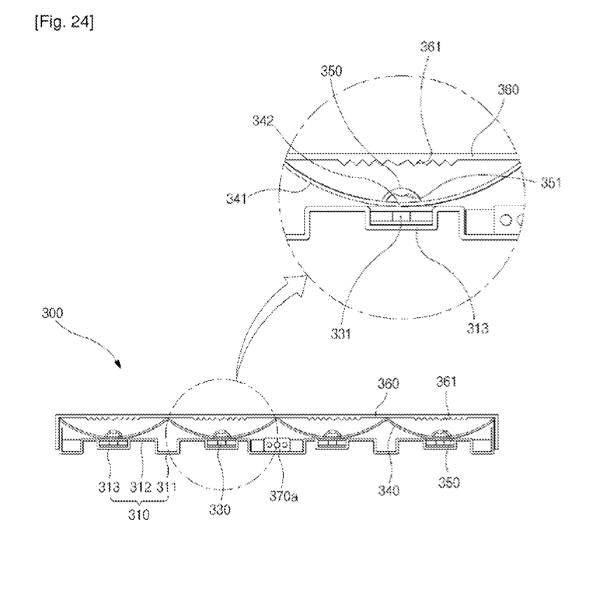

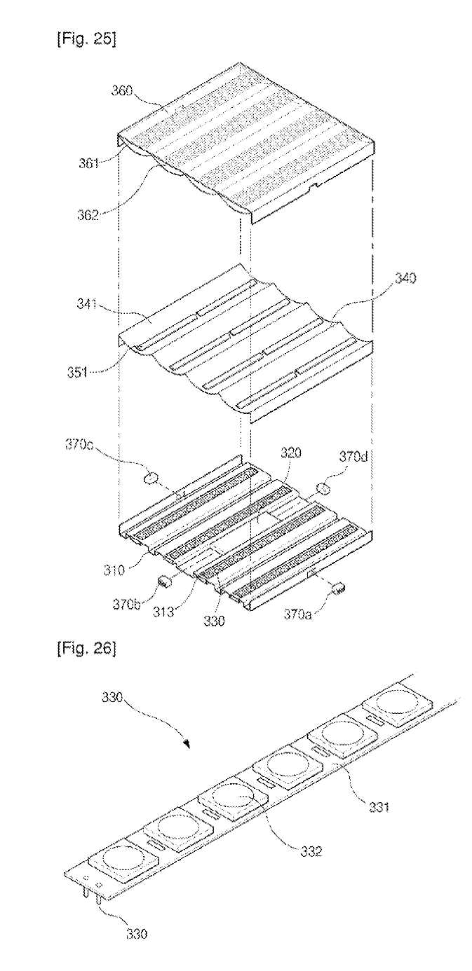

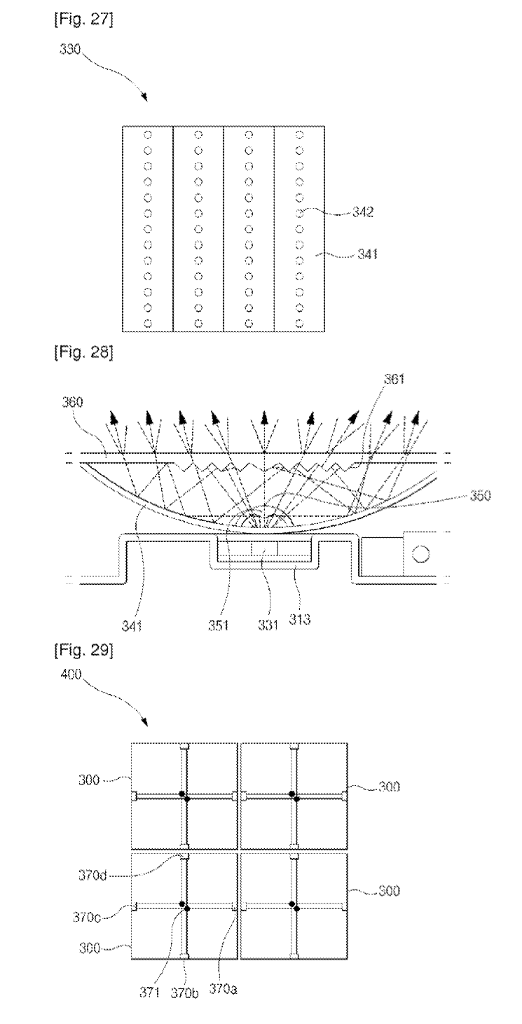

A panel-shaped LED lighting device 300 according to an embodiment of the present invention rapidly and effectively discharges heat generated from LED elements 332 at the time when the LED elements 332 constituting an LED module 330 emit light with high luminance and high power to increase optical output and optical efficiency, and remarkably extend the lifespan thereof and effectively prevent a glaring phenomenon by high-luminance light emission of the LED elements 332 and widely diffuse the light of the LED elements 332 without attenuation as shown in FIGS. 23 to 29. As shown in FIGS. 23 to 27, the panel-shaped LED lighting device 300 includes heat dissipating plates 310 in which recessed portions 311 and projected portions 312 are continuously formed and light source mounting grooves 313 are formed in the projected portions 312, respectively, power supply controllers 320 installed on the heat dissipating plates 310, LED modules 330 mounted on the light source mounting grooves 313 of the heat dissipating plates 310 and electrically connected to the power supply controllers 320 to flicker on and off by controls from the power supply controllers 320, reflecting plates 340 in which curved reflecting portions 341 coupled to front surfaces of the heat dissipating plates 310 and having downward semicircular cross sections are formed continuously to correspond to the light source mounting grooves 313 and the bottoms of the curved reflecting portions 341 are bored to correspond to the LED modules 330, semicircular diffusion lenses 350 installed on the front bottoms of the curved reflecting portions 341 of the reflecting plates 340 and covering emission surfaces of the LED modules 330, and diffusion plates 360 coupled to the front surfaces of the reflecting plates 340 and covering the front surfaces of the reflecting plates 340.

Herein, the heat dissipating plates 310 form a rear panel of the panel-shaped LED lighting device 300 according to the embodiment of the present invention and discharges heat generated when the LED modules 330 to be described later emit light with high luminance and high power to the outside through heat exchange with external air. The heat dissipating plates 310 are formed by a metal plate so that the recessed portions 311 and the projected portions 312 are continuously formed to show a good heat dissipating effect through increment of a heat exchange area.

The light source mounting grooves 313 are formed at the projected portions 312 of the heat dissipating plates 310. The light source mounting grooves 313 form mounting spaces of the LED modules 330 to be described later and serve to further increase the heat exchange areas of the heat dissipating plates 310.

The power supply controller 320 is installed at the recessed portion 311 positioned at the center of the heat dissipating plate 310. The power supply controller 320 supplies a power introduced from the outside to each LED module 330 to control flickering of the LED module 330 and transfer the introduced power to connectors 370a to 370b to be described later.

The LED module 330 is mounted at the light source mounting groove 313 of the heat dissipating plate 310. The LED module 330 serves as a light source in the panel-shaped LED lighting device 300 according to the embodiment of the present invention and is electrically connected to the power supply controller 320 to flicker by the control from the power supply controller 320.

In the LED module 330, as shown in FIG. 26, a plurality of LED elements 332 are spaced apart from each other on a bar-type printed circuit board 331 and connection terminals 333 for electrically connecting the power supply controller 320 are provided at one side of the bar-type printed circuit board 331. Diversified light emitting circuit elements including resistors are provided on the printed circuit board 331 and the LED elements 332 are preferably formed as an LED package that can emit light with high luminance and the connection terminal 333 is electrically connected to the power supply controller 320 by an additional power supply connector (not shown) to receive the power.

In particular, the LED elements 332 that are generally manufactured by packaging a plurality of LEDs in order to acquire a high-luminance lighting light source have a structure to collect light on a front surface and emit the collected light by using a small reflecting mirror and an epoxy lens as a part of an optical design to structurally minimize light loss by opaque components such as a substrate, an electrode, a heat dissipater, and the like. The light sources of the LED elements 332 have various forms of directionalities according to the structures of the reflecting mirror and the epoxy lens.

The LED module 330 is merely one embodiment of the LED module 330 used in the LED lighting device 300 according to the embodiment of the present invention and a specialized manufactured power LED module or an AC LED module are configured in a bar type to be used according to the usage or illumination of the LED lighting device.

It is preferable that the LED module 330 is replaceably mounted in the light source mounting groove 313 of the heat dissipating plate 310 and this is possible by attach and detach the connection terminal 333 to and from a power supply connection connector (not shown), and as a result, only the LED module 330 having deteriorated illumination is replaced; however, the rest of the components of the LED lighting device 300 can be used semipermanently.

The reflecting plate 340 is coupled to the front surface of the heat dissipating plate 310. The reflecting plate 340 serves to reflect the entire light emitted from all the LED elements 332 of the LED module 330 to the front side and is formed by a metal plate so that a lower end of the curved reflecting portion 341 having a downward semicircular cross section is in close contact with the light source mounting groove 313.

Further, boring holes 342 corresponding to locations of the emission surfaces of the LED elements 332, respectively are formed on the lower end of the curved reflecting portion 341 so that the light sources of the LED elements 332 arranged on the LED module 330 are projected onto the reflecting plates 340. As a result, the light emitted from the emission surface of the LED element 332 is absorbed in circuit components of the LED module 330 or the printed circuit board (PCB) 331, or a part of a frame not to be attenuated.

The inner periphery of the reflecting plate 340 is fitted in an outer portion of the heat dissipating plate 310 so that the boring holes 342 on the lower end of the reflecting plate 340 is supported in contact with the periphery of the emission surface of the LED element 332. As a result, heat discharged to the top of the LED element 332 is rapidly discharged through the bottom of the curved reflecting portion 341 by the boring holes 342 supported on the emission surface of the LED element 332 to thereby increase the optical output and lifespan of the LED element 332.

The reflecting plate 340 is further preferably manufactured by forming the metal plate so that the curved reflecting portions 341 are continuously and plating the surface thereof with chrome or nickel so as to maximize light reflection efficiency.

The semicircular diffusion lenses 350 are installed on the front bottom of the curved reflecting portions 341 of the reflecting plate 340, respectively to cover the emission surface of the LED module 330. The semicircular diffusion lenses 350 serve to widely diffuse the light of the LED element 332 passing through the boring hole 342 of the reflecting plate 340 semicircularly.

An inverted triangular lens surface 351 having a prism shape is formed on the inner surface of the semicircular diffusion lens 350. The inverted triangular lens surface 351 serves to full-reflect the light of the LED element 332 to the curved reflecting portion 341 of the reflecting plate 340 without attenuation by an angle thereof. In particular, it is more advantageous in wide diffusion of the light that a part of the light of the LED element 332 is not progressed straight at the center of the inverted triangular lens surface 351 but full-reflected to the curved reflecting portion 341 of the reflecting plate 340 at the side thereof and thereafter, reflected to the front side by the curved reflecting portion 341 again.

In optics, the full-reflection represents a phenomenon in which when light is progressed from a material having optically large refractivity to a material having optically small refractivity, light incident at an incident angle larger than a predetermined threshold angle is not refracted but fully reflected and the minimum value of the incident angle at which the full-reflection may occur is referred to as the threshold angle. For example, a threshold angle at which light is progressed from glass to air is 42 degrees and if the incident angle is larger than 42 degrees, light cannot transmit the glass and is fully reflected on the inner surface of the glass not to be progressed to air. The phenomenon is referred to as the full-reflection and the inverted triangular lens surface 351 of the present invention configures a kind of full-reflection prism to serve to change a progressing direction of light.

The diffusion plate 360 is coupled to the front surface of the reflecting plate 340. The diffusion plate 360 covers the front surface of the reflecting plate 340 to form a front panel of the panel-shaped LED lighting device 300 according to the embodiment of the present invention.

A toothed diffusion lens 361 in which a plurality of prisms are continuously formed is formed on the bottom of the diffusion plate 360 corresponding to the LED module 330. By using the toothed diffusion lens 361, diffused light reflected by the curved reflecting portion 341 is further diffused by mutual reflection operations between the toothed diffusion lens 361 and the curved reflecting portion 341, such that high-luminance light is not attenuated and glaring can be prevented. Side cover portion 362 covering a side space by the curved reflecting portion 341 are integrally formed on both surfaces of the diffusion plate 360.

FIG. 28 is a diagram showing a light diffusion operation of an LED light source in the panel-shaped LED lighting device according to the embodiment of the present invention.

The panel-shaped LED lighting device 300 according to the present invention is configured to diffuse high-luminance light emitted from the LED element 332 without glaring through multi-stage diffusion operations without attenuation through a 3D combination of the reflecting plate 340, the semicircular diffusion lens 350, and the diffusion plate 360 as shown in FIG. 28 in order to prevent the high-luminance light glare of the LED element 332 which is a semiconductor point light source.

To this end, the reflecting plate 340 installed on the top of the LED element 332 is plated with chrome or nickel to form the curved reflecting portion 341 having maximized reflectivity and the semicircular diffusion lens 350 having the inverted triangular lens surface 351 is mounted on the central upper portion of the curved reflecting portion 341, such that the light emitted from the LED element 332 is refracted and diffused through the semicircular diffusion lens 350 having the inverted triangular lens surface 351 and projected to the curved reflecting portion 341 and reflected to the front side and thereafter, a part of the reflected light is re-reflected by the toothed diffusion lens 361 of the diffusion plate 360 positioned on the top thereof to diffuse the light more effectively. Therefore, the light becomes soft illuminating light of which the glare is prevented.

Connectors 370a to 370d are preferably installed on sides of the heat dissipating plate 310, which enable extension to a large surface lighting device 400 through power supply connection and interconnections of the panel-shaped LED lighting devices 300 according to the present invention by being electrically connected to the power supply controllers 320. FIG. 29 is a schematic structural diagram of a large surface lighting device implemented by connecting four panel-shaped LED lighting devices 300 according to the present invention in horizontal and vertical directions by using the connectors 370a to 370d.

As shown in FIG. 29, as the panel-shaped LED lighting device 300 according to the present invention is formed in a square shape and the connectors 370a to 370d are provided at the centers of the sides one at a time, grid-shaped power supply circuits may be implemented between the power supply controller 320 and the connectors 370a to 370d at the center. In this case, the connectors 370a to 370d on four surfaces are connected to each other in pairs of the same electrodes by grid-shaped connection terminals 371.

Further, in the case where the panel-shaped LED lighting devices 300 according to the present invention are connected to each other in the horizontal and vertical directions by using the connectors 370a to 370d to extend to the large surface lighting device 400, a generally net type power supply circuit is implemented by power supply circuits. Since no potential difference is generated among the LED lighting devices 300 connected to each other due to a characteristic of the net type serial/parallel power supply circuit, even when the large surface lighting device 400 is constructed by extending a large number of panel type LED lighting devices 300, there is no difference in illumination on the whole, as a result, it is possible to achieve uniform lighting.

The panel-shaped LED lighting device 300 according to the present invention may be used for a ceiling lighting device in itself by replacing the existing ceiling lighting lamp and is easily extended in the horizontal and vertical directions to be used as the large surface lighting device 400.

In this case, it is possible to easily connect the external power supply at the time of installing the lighting device through the connectors 370a to 370d and extend the lighting device in the horizontal and vertical direction without an additional connection wire by interconnecting the connectors 370a to 370d even at the time of constructing the large surface lighting device 400 on a ceiling or a wall.

### INDUSTRIAL APPLICABILITY

According to an embodiment of the present invention, it is possible to provide a lamp-shaped LED lighting device that can prevent an LED light source from being glared and widely diffuse a light source without optical attenuation while rapidly discharging heat generated from the top and bottom of an LED element by a heat dissipating frame and a side reflecting member and can replace an incandescent light bulb and a fluorescent lamp.

According to another embodiment of the present invention, it is possible to provide a line-shaped LED lighting device that can prevent an LED light source from being glared and widely diffuse a light source without optical attenuation while rapidly discharging heat generated from the top and bottom of an LED element by a line-shaped structure base frame and a curved reflecting plate and can replace a line-shaped fluorescent lamp.

According to yet another embodiment of the present invention, it is possible to provide a line-shaped LED lighting device that can prevent an LED light source from being glared and widely diffuse a light source without optical attenuation while rapidly discharging heat generated from an LED element through a heat dissipating plate having a panel-shaped structure which smoothly dissipates heat, a curved reflecting plate, and a 3D light diffusion plate and uniformly diffuse a light source without optical attenuation to prevent a light output from being reduced and the lifespan from being extended and can replace a panel-shaped LED lighting device capable of efficiently a surface lighting device.

1. A lamp-shaped LED lighting device, comprising:
a housing cover having a socket fixed at one side thereof;
a heat dissipating frame fixed to the other side of the housing cover, having at least three side reflecting portions formed on the outer peripheral surface thereof, and a ventilation unit having at least one ventilation hole formed at a portion which the end of the side reflecting portion contacts;
an LED module fixed to the side reflecting portion of the heat dissipating frame and having an LED element;
a power supply module unit installed in the heat dissipating frame;
a side reflecting member fixed to the side reflecting portion of the heat dissipating frame to cover the LED module and having a boring hole formed at a location corresponding to an emission surface of the LED element;
a frame cover coupled to be attached to and detached from the bottom of the heat dissipating frame; and
a diffusion cover mounted on the side reflecting portion of the heat dissipating frame and having a toothed diffusion lens serving as refraction and diffusion operations installed on the inner periphery thereof,
wherein at least one housing hole is formed on the housing cover.

2. A lamp-shaped LED lighting device, comprising:
a housing cover having a socket fixed at one side thereof;
a power supply module housing coupled to be attached to and detached from the other side of the housing cover;
a heat dissipating frame fixed to one side of the power supply module housing, having at least three side reflecting portions formed on the outer peripheral surface thereof, and a ventilation unit having at least one ventilation hole formed at a portion which the end of the side reflecting portion contacts;
an LED module fixed to the side reflecting portion of the heat dissipating frame and having an LED element;
a power supply module unit installed in the power supply module housing;
a side reflecting member fixed to the side reflecting portion of the heat dissipating frame to cover the LED module and having a boring hole formed at a location corresponding to an emission surface of the LED element;
a frame cover coupled to be attached to and detached from the bottom of the heat dissipating frame; and
a diffusion cover mounted on the side reflecting portion of the heat dissipating frame and having a toothed diffusion lens serving as refraction and diffusion operations installed on the inner periphery thereof,
wherein at least one housing hole is formed on the housing cover.

3. The lamp-shaped LED lighting device of claim 1, wherein an optical sensor is installed at one side of the frame cover.

4. The lamp-shaped LED lighting device of claim 3, wherein a diffusion lens diffusing a light source emitted from the LED module is installed in the side reflecting member.

5. The lamp-shaped LED lighting device of claim 4, wherein a control unit controlling illumination of the LED module is installed in the power supply module unit.

6. The lamp-shaped LED lighting device of claim 5, wherein a prism is formed in the diffusion lens of the side reflecting member.

7. A lamp-shaped LED lighting device, wherein at least one frame cover hole is formed in the frame cover.

8. The lamp-shaped LED lighting device of claim 7, wherein the toothed diffusion lens of the diffusion cover is formed by a Fresnel lens.

9. The lamp-shaped LED lighting device of claim 8, wherein the side reflecting member is plated with chrome or nickel.

10. The lamp-shaped LED lighting device of claim 9, wherein a dome-shaped reflecting mirror is installed at the center of the frame cover and an LED lamp is installed in the reflecting mirror.

11. The lamp-shaped LED lighting device of claim 10, wherein the LED module is replaceable by the side reflecting member and the frame cover separated from the heat dissipating frame.

12. A line-shaped LED lighting device, comprising:
a base frame partitioned into an upper space part and a lower space part, having a bent side wall, and having at least one frame ventilation hole formed on the side wall;
an LED module installed in the upper space part of the base frame and having an LED element;
a curved reflecting plate in which the end is supported on the upper space part of the base frame, a boring hole is formed at a location corresponding to an emission surface of the LED element, and a diffusion lens is installed on a straight line with the LED module;
a diffusion plate fixed to the top of the base frame;
a side cover coupled to the side of the base frame and connecting a power to the LED module; and
a power supply module unit coupled to the side cover to supply the power to the LED module,
wherein a toothed diffusion lens performing refraction and diffusion operations is installed on the diffusion plate.

13. The line-shaped LED lighting device of claim 12, further comprising a diffusion window fixed to the top of the base frame to cover the diffusion plate.

14. The line-shaped LED lighting device of claim 13, further comprising a frame supporting unit coupled to be attached to and detached from the base frame and having at least one heat dissipating pin and a ventilation hole formed on the side wall.

15. The line-shaped LED lighting device of claim 13, wherein an optical sensor and a control unit are installed in the power supply module unit and the control unit is connected with the power supply module unit and the optical sensor to automatically control illumination of the LED module.

16. The line-shaped LED lighting device of claim 15, wherein a prism is formed in the diffusion lens of the curved reflecting plate.

17. The line-shaped LED lighting device of claim 16, wherein a lenticular lens is installed in the diffusion window.

18. The line-shaped LED lighting device of claim 17, wherein a diffusion prism is further installed in the diffusion plate.

19. The line-shaped LED lighting device of claim 18, wherein the curved reflecting plate is plated with chrome or nickel.

20. A panel-shaped LED lighting device, comprising:
a heat dissipating plate in which recessed portions and projected portions are continuously formed and light source mounting grooves are formed in the projected portions;
a power supply controller installed on the heat dissipating plate;
an LED module mounted in the light source mounting groove of the heat dissipating plate and electrically connected to the power supply controller to flicker by a control from the power supply controller;
a reflecting plate in which curved reflecting portions coupled to a front surface of the heat dissipating plate and having a downward semicircular cross section are continuously formed and a boring hole is formed on the bottom of the curved reflecting portion;
a semicircular diffusion lens installed on the front bottom of the curved reflecting portion to cover the boring hole of the curved reflecting portion; and
a diffusion plate coupled to the front surface of the reflecting plate to cover the front surface of the reflecting plate.

21. The panel-shaped LED lighting device of claim 20, further comprising connectors provided on sides of the heat dissipating plate, which enable extension to a large surface lighting device through power supply connection and interconnections of the LED lighting devices by being electrically connected to the power supply controllers.

22. The panel-shaped LED lighting device of claim 20, wherein in the LED module, a plurality of LED elements are spaced apart from each other on a bar-type printed circuit board and connection terminals for electrically connecting the power supply controller are provided at one side thereof.

23. The panel-shaped LED lighting device of claim 20, wherein the LED module is replaceably mounted in the light source mounting groove.

24. The panel-shaped LED lighting device of claim 23, wherein boring holes are formed at only locations of the curved reflecting portion of the reflecting plate corresponding to the LED elements so that only light sources of the LED elements arranged in the LED module are projected onto the reflecting plate and the boring holes of the reflecting plate are supported in contact with the periphery of the emission surface of the LED element at the time of coupling the reflecting plate.

25. The panel-shaped LED lighting device of claim 20, wherein the reflecting plate is manufactured by forming a metal plate so that the curved reflecting portions are continuously formed and plating the surface thereof with chrome or nickel.

26. The panel-shaped LED lighting device of claim 20, wherein an inverted triangular lens surface having a prism shape performing a full-reflection operation is formed on the inner surface of the semicircular diffusion lens.

27. The panel-shaped LED lighting device of claim 20, wherein a prism-type toothed diffusion lens is formed on the bottom of the diffusion plate corresponding to the LED module.

28. The panel-shaped LED lighting device of claim 21, wherein as the panel-shaped LED lighting device is formed in a square shape and the connectors are provided at the centers of the sides one at a time, grid-shaped power supply circuits are implemented between the power supply controller and the connectors at the center and in the case where the panel-shaped LED lighting devices are connected to each other in horizontal and vertical directions by using the connectors to extend to the large surface lighting device, a generally net type power supply circuit is implemented by power supply circuits.
